(19) United States
(12) Patent Application Publication
(10) Pub. No.: US 2004/0200857 A1
(43) Pub. Date: Oct. 14, 2004

(54) Dispenser for hardenable viscous pasty compound

(76) Inventor: Alfred von Schuckmann, Kevelaer (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/820,332

(22) Filed: Apr. 8, 2004

(30) Foreign Application Priority Data
Apr. 11, 2003 (DE) 103 16 792.7
May 17, 2003 (DE) 103 22 354.1

(51) Int. Cl. B67D 5/52

(52) U.S. Cl. 222/137; 222/207; 222/145.6; 222/321.7

(57) ABSTRACT

A dispenser (1) for filling a to-be-filled part (3) with a hardenable, viscous, pasty compound (6), includes a multi-part housing (21) having telescopingly arranged within each other, telescoping housing parts (22, 23) and a dispensing opening (9), a supply chamber (16) for storing the hardenable, viscous, pasty compound (6), a variable pump chamber (17) for delivering the compound through the dispensing opening (8) and adjoining the supply chamber (16), a cover (18) for covering the pump chamber (17) and displaceable relative to the pump chamber (17) between a first position, in which the pump chamber (17) has an initial volume, and a second position in which the pump chamber (17) has a reduced volume; and a reset spring (32) arranged outside of the pump chamber (17) for biasing the pump chamber cover (18) to the first position.

### BACKGROUND AND SUMMARY OF THE INVENTION

The present invention relates to a dispenser for dispensing a hardenable viscous pasty compound stored in a supply container.

An object of the present invention is to provide a dispenser for an effective dispensing of a hardenable, preferably, high viscous pasty compound.

This and other objects of the present invention, which will become apparent hereinafter, are achieved by providing a dispenser for filling a to-be-filled part with a hardenable, viscous, pasty compound and including a multi-part housing having telescopingly arranged within each other, telescoping housing parts and a dispensing opening, a supply chamber for storing the hardenable, viscous, pasty compound, a variable pump chamber for delivering the compound through the dispensing opening and adjoining the supply chamber, a cover for covering the pump chamber and displaceable relative to the pump chamber between a first position, in which the pump chamber has an initial volume, and a second position in which the pump chamber has a reduced volume; and a reset spring arranged outside of the pump chamber for generating a spring force which causes the housing parts to displace away from each other which results in displacement of the pump chamber cover to its first position.

The delivery of the compound through the dispensing opening is effected by applying a compression force to a rear, with respect to a delivery direction, side of the housing, whereby the dispensing opening is pressed against the to-be-filled part, and the volume of the pump chamber is reduced as a result of the pump chamber cover being displaced to its second position in response to telescopic displacement of the housing parts toward each other under action of the compression force applied to the rear side of the housing. The pump chamber is refilled by the compound upon removal of the compression force and displacement of the pump chamber cover to its first position which is a result of displacement of the telescoping housing parts away from each other under action of the spring force of the reset spring.

In consequence of such a configuration, a reliably functioning dispenser of enhanced utility is obtained. Delivery and refill occur under a positive control. There is provided a combination of dispenser and tool. The whole combination is comfortably held in hand. Even a highly-viscous compound is smoothly and powerfully applied to the target site, even if obstacles such as mixed materials inhibiting flow intervene. The durable part to-be-filled with a high-strength adhesive can sustain high loads after hardening. The handling in a specific direction by a telescoping displacement of the housing parts effects a desirable concentration at the transition point in the direction of the part to be filled. The telescoping displacement is used also for the pumping action. Forcing out of the quantity of viscous pasty compound present in the pump chamber is effected by displacement of the telescoping housing parts toward each other that results in reduction of the volume of the pump chamber which is caused by a manually pressing force directed towards the dispensing opening and against the part to be filled. When the corresponding manual force is removed, the pump chamber returns to its normal position under a positive control. This is achieved simply by tractive pulling back of the pump chamber cover, again controlled by the telescoping housing parts, with aid of the reset spring. This results in precisely reproducible doses. Accordingly, filling of the dowel-free wall fastening elements is achieved in an operationally reliable manner. A brief attachment of the part to be filled makes it possible to position the next part to be filled. The forced-out air passes through a corresponding balancing opening.

The telescoping housing parts are connected by a lever transmission system that provides for telescopically displacement of the housing parts, which makes it possible to use a moderate hand force so that the user can better concentrate on the exact targets. Accordingly, a weaker reset spring is used. It is expedient when the housing parts are indirectly connected by the lever transmission system. This type of connection can be provided simply by using a ring member.

It is further advantageous, when the manual force is applied to the upper housing part, relative to which both telescoping housing parts are movable. When this is done, measures for improved gripping can be applied as well as ergonomic means. One design of even more automatic significance is achieved by forming the dispenser of an operating part and a replaceable supply part, with the telescoping housing parts and the upper housing part being provided on the operating part, and the dispenser opening, the pump chamber and the supply chamber being provided on the supply part. Also conceivable the use of a cartridge. An appropriate cartridge mounting can be best effected when the dispenser, in this case on the operating part, has a receptacle opening transversely to the direction of operation for the supply part. In this case, in the course of pushing in of the supply part into the receptacle, both an axial locking of the pump chamber cover and of the supply chamber in respective telescoping housing parts takes place. In the interest of achieving exactly meterable, varying delivery quantities, it can be advantageous, if the telescoping is selected based on a stroke length. In the case of utilization of a two-component compound, it is expedient to position a mixing segment upstream of the part to be filled and in the dispensing opening. In order that the dispenser even at the time of initial use immediately responds in terms of delivery, it is recommended that a filling column with a stopper for urging the compound level be associated with the supply chamber. The compound filled in up to the edge of the filling column is pressed into the head zone of the dispenser. It is further proposed that the pump chamber be formed by a roll bellows.

The invention also relates to a supply part, for a dispenser described above and having a supply magazine, a pump chamber, and a dispensing opening configured at a mouthpiece, with the mouthpiece being connected with a pump chamber cover and having a first locking formation, with the supply chamber being provided with a second locking formation. With regard to the two-component supply, the supply part is configured as a two-chamber element (twin cartridge), with each cartridge having an outlet connected to the mouth area. In consideration of a sufficient expulsion pressure required to discharge a highly viscous compounds it is advantageous, that each is taken from a supply chamber containing a dimensionally stable container formed of an invertable bellows, which, upon emptying of the mouthpieces, inverts into the other supply chamber half as the result of a partial vacuum caused by the emptying created by the mouthpiece pump. A stable embodiment of the supply part is attained when a protruding edge of the bellows is gripped flangelike in the zone of the equatorial connection joint of two container shell halves.

The novel features of the present invention, which are considered as characteristic for the invention, are set forth in the appended claims. The invention itself, however both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side view of a dispenser according to the present invention, equipped with a replaceable supply part in its initial position;

FIG. 2 a bottom view of the dispenser shown in FIG. 1;

FIG. 3 a side view of the supply part;

FIG. 4 a plan view of the supply part;

FIG. 5 a perspective view of the end section of a telescopic housing part;

FIG. 6 a side, partially cross-section of the dispenser; which is shown in FIG. 1, in the initial position;

FIG. 7 a view similar to that of FIG. 6 but with the dispenser effecting a first delivery stroke and without the supply part being shown;

FIG. 8 a cross-sectional view showing a docking region of the dispenser connected to a to-be-filled part fastenable to a wall;

FIG. 9 a cross-sectional view of a Region IX in FIG. 8 at an increased, in comparison with FIG. 8, scale;

FIG. 10 a cross-sectional view along line X-X in FIG. 8;

FIG. 11 a view of a supply part somewhat similar to that of FIG. 3 and illustrating an inverted bellows arrangement;

FIG. 12 a cross-sectional view showing Region XII in FIG. 11;

FIG. 13 a cross-sectional view showing the Region XIII in FIG. 11;

FIG. 14 a side view of another embodiment of the supply part;

FIG. 15 a cross-sectional view showing a plunger formed as a roll bellows; and

FIG. 16 a cross-sectional view showing the roll bellows of FIG. 15 in an actuated condition.

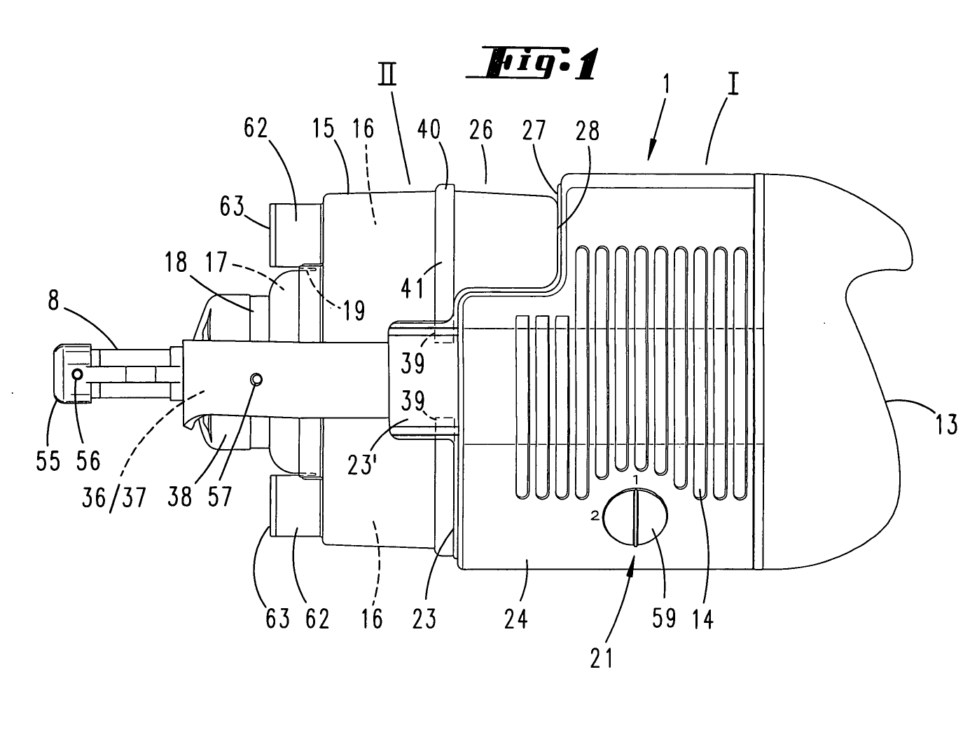

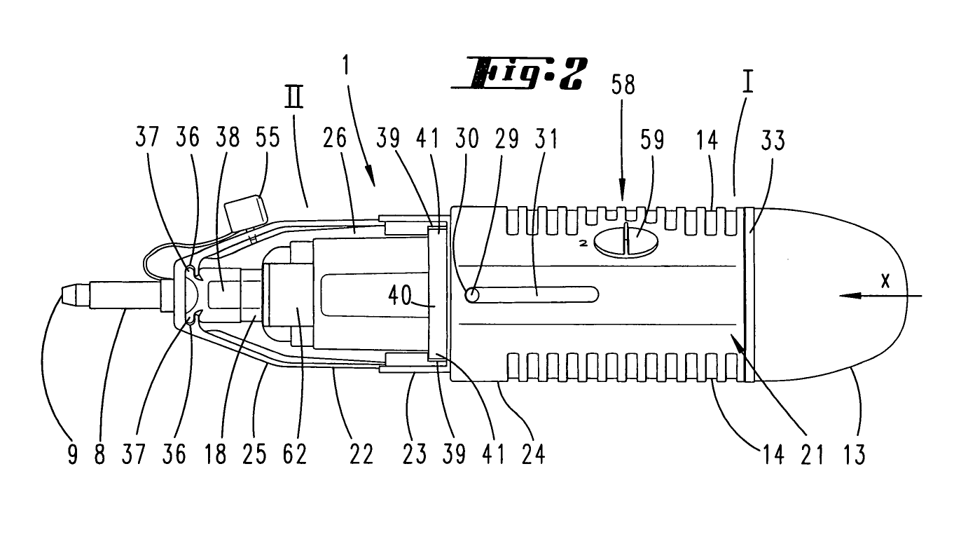

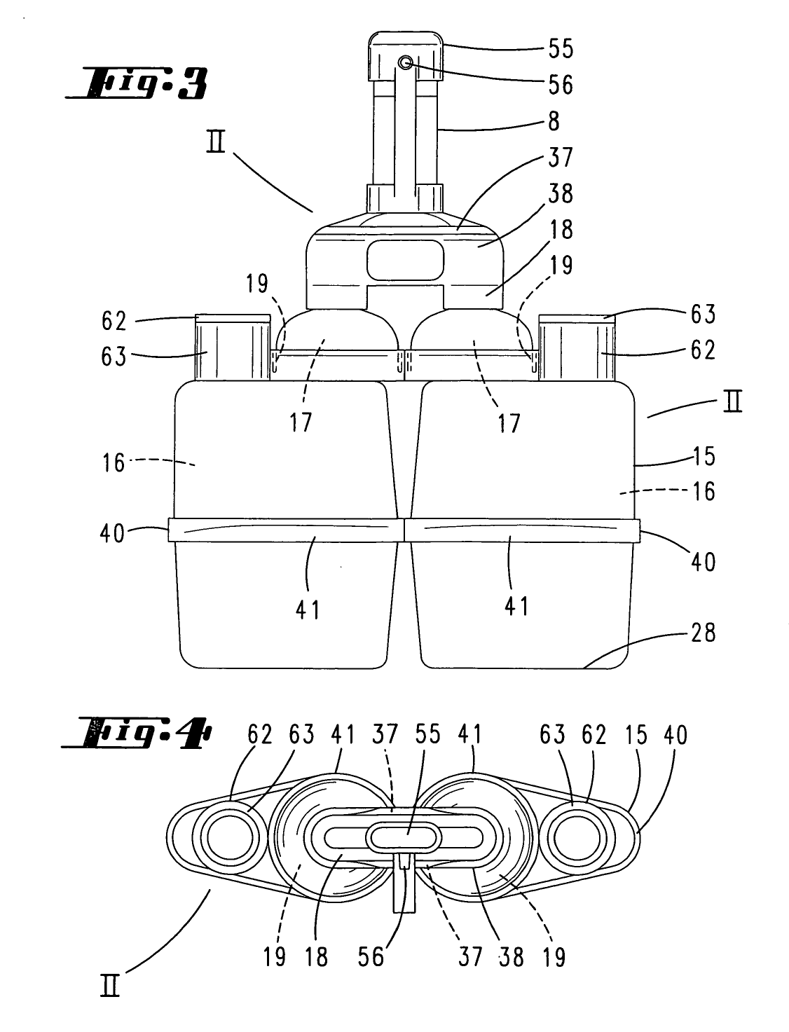

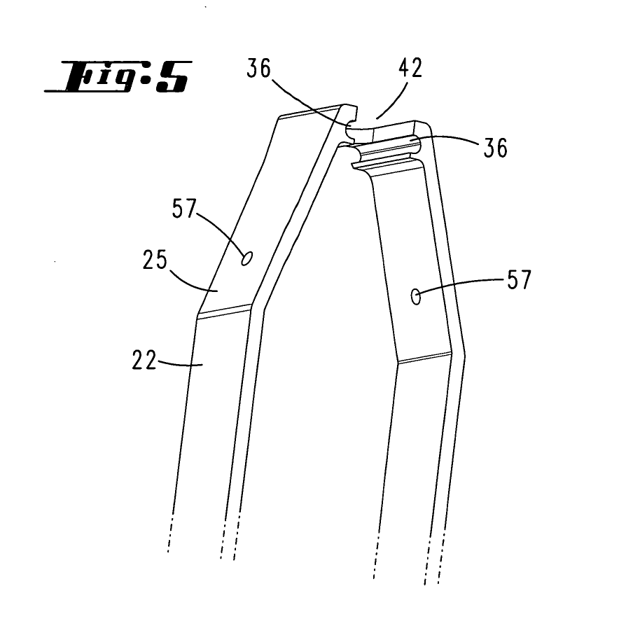

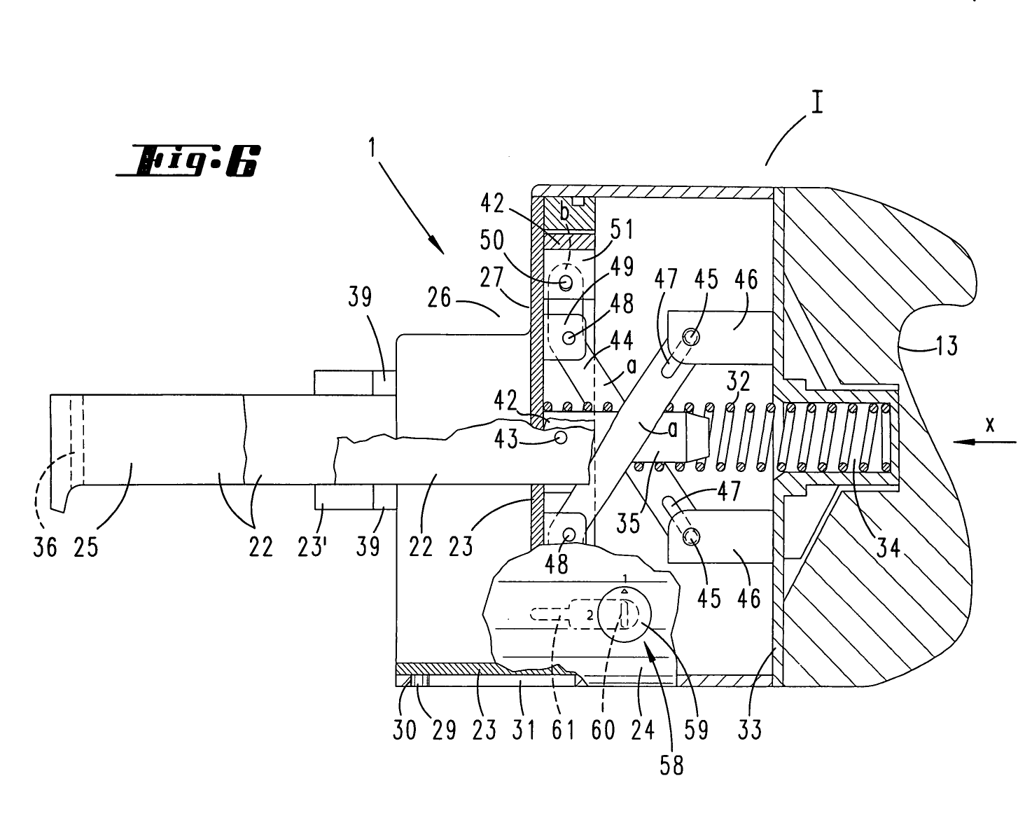

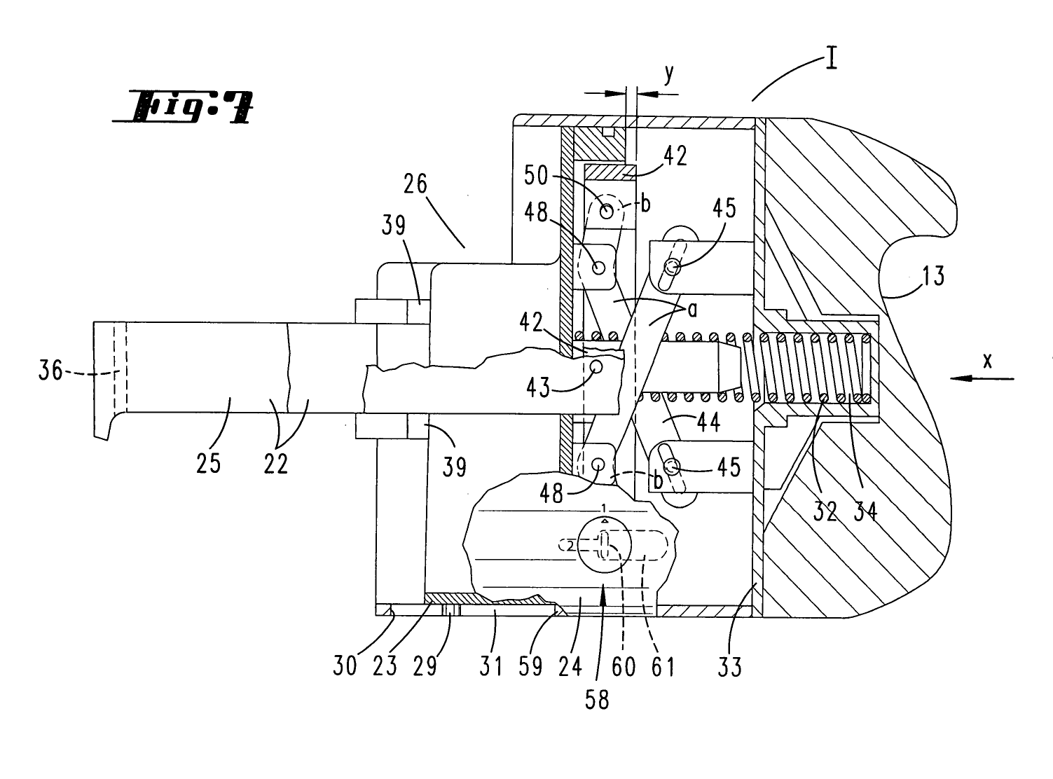

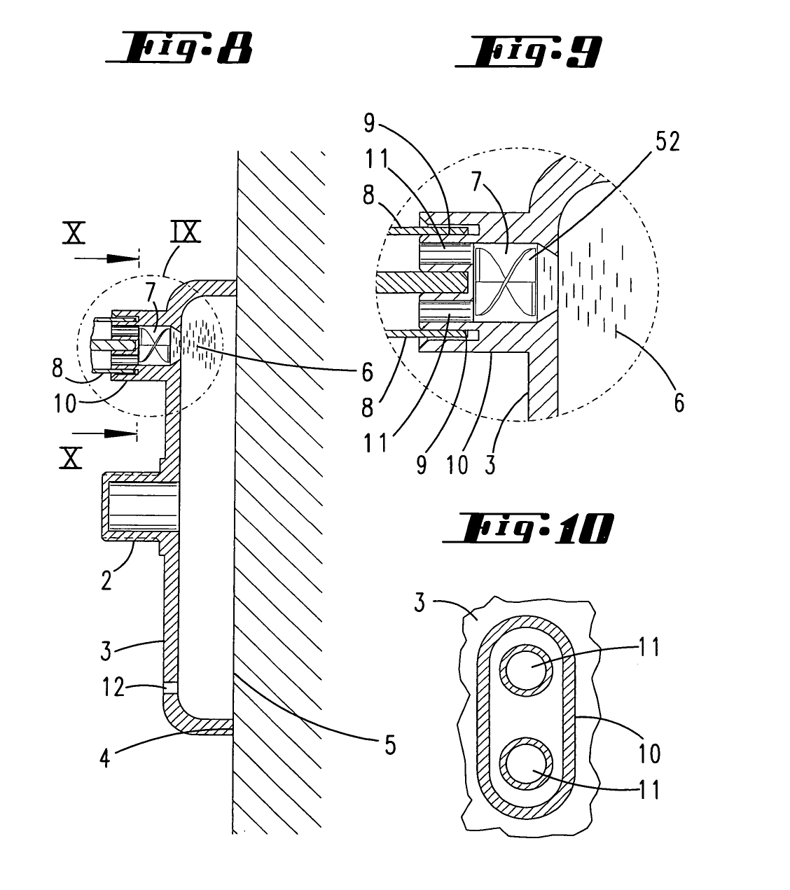

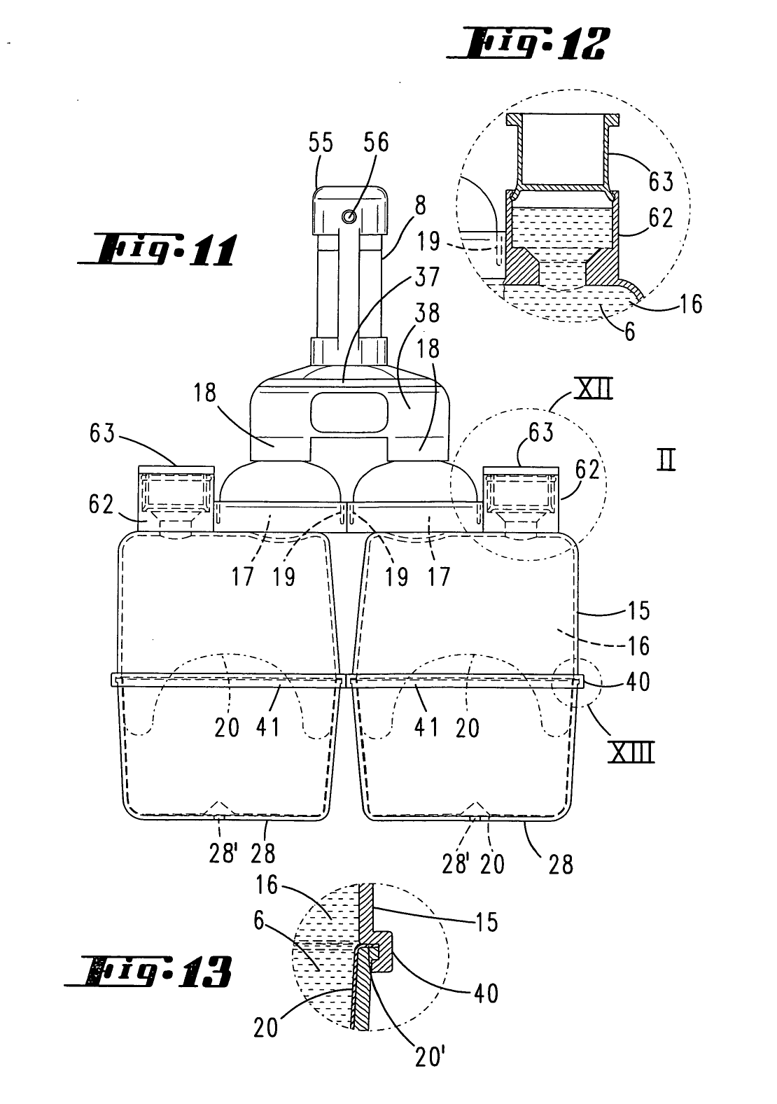

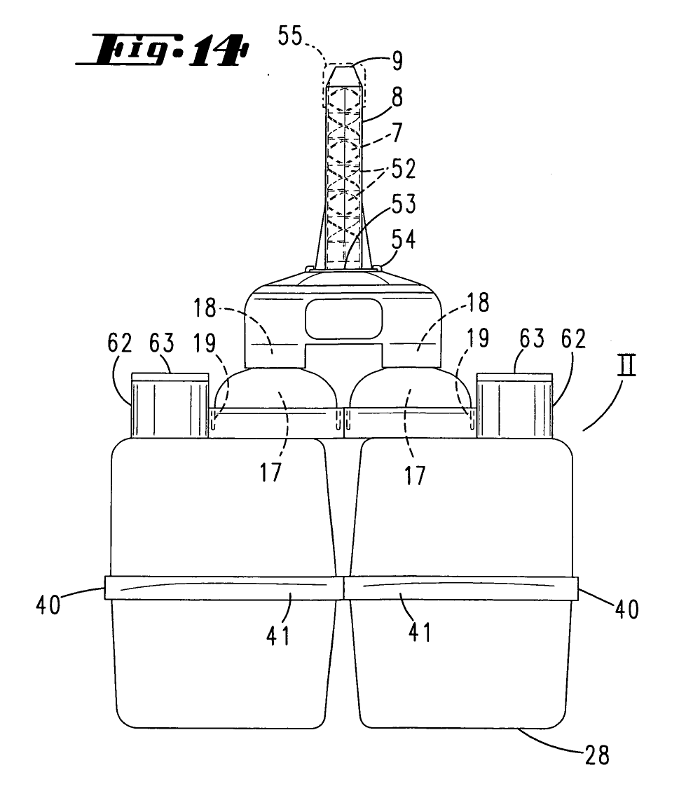

### DETAILED DESCRIPTION OF THE PREFERRED EMBODIMENT

A dispenser 1 according to the present invention, which is shown in the drawings, is formed as an elongate, substantially flat, hand-held tool and is used for performing a press-gluing operation. The dispenser 1 fills a to-be-filled part 3 that includes a fastening element 2 formed as a threaded fastening element.

The to-be-filled part 3, which is shown in FIG. 8, has a cup-shaped form, with the circumferential cup edge 4 sealingly abutting a substantially flat wall surface 5 or the like of a constructional part. Also, an adhesive ring can be provided. Thereby, a circumferentially closed, to-be-filled region is formed, which is filled with a hardenable, viscous, pasty compound 6 by using the dispenser 1. The compound 6 is supplied from two sources, being formed thus as a two-component compound. The two components of the compound 6 are intermixed in a mixing path 7 that forms part of either the to-be-filled part 3 or the dispenser 1.

The dispenser 1 has a double-channel mouthpiece 8, with the channels forming dispensing openings 9.

The mouthpiece 8 with two dispensing openings 9 is sealingly connected with a union 10 of the to-be-filled part 3, forming a double channel, tubular inlet opening 11, with the plug parts being beveled or funneled.

The air, which is forced out during filling, escapes through an outlet 12. Thereby a predetermined filling sequence is controlled.

The dispenser 1 operates based on a pumping principle and is formed of two parts, an operating part I and a supply part II. The operating part I is ergonomically designed, so that it lies comfortably in the hand of the operator. The completely grippable end is formed as a pistol grip 13. The wide sides of the operating part I are roughened, provided, preferably, with vertical ridges. The ridges are shown with a reference numeral 14. The overall cross-section of the operating part I is flat, box-shaped with, preferably, convexly rounded longitudinal edges and flattened wide sides.

The supply part II can be an integral part of the dispenser 1. Preferably the supply part II is, however, formed as a replaceable part in a form of a cartridge 15, in particular as a twin cartridge forming a supply chamber 16 of the supply part II.

The supply chamber 16 communicates with the pump chamber 17. The pump chamber 17 is closed, at its side adjacent to the mouthpiece 8, with a cover 18. With the latter, a volume reduction of the pump chamber 17 is effected, producing a pumping action.

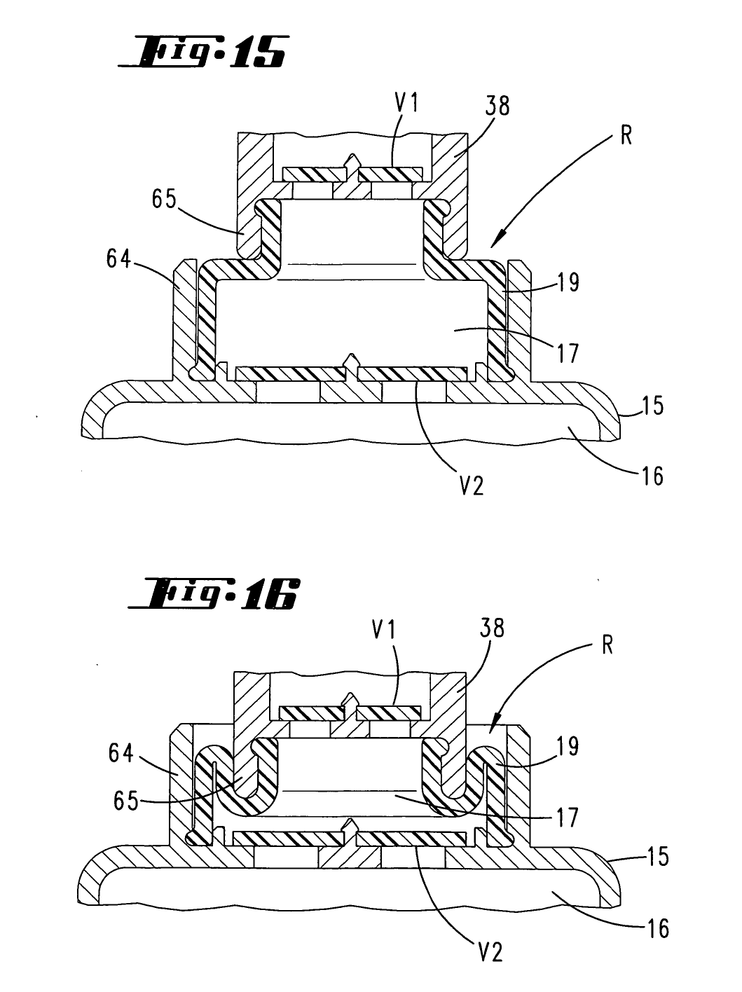

The pump chamber 17, can be formed as a dome-shaped bellows. Preferably, the pump chamber 17 is formed as a roll bellows 19, as represented in FIGS. 15 and 16.

The pump chamber cover 18 has an outlet valve V1, and the pump chamber 17 has an inlet valve V2 as shown in FIGS. 15-16.

A wall 64 is formed adjacent to the pump chamber 17, externally to the roll bellows 19. The wall extends over the entire height of the pump chamber, with the exception of the downwardly extending extension 65 formed on the pump chamber cover 18. The roll bellows of this type of a roll pump R does not have a reset force. It is essential that a very high metering precision is attained herein.

The actuated condition of the bellows 19 is illustrated in FIG. 16. It can be seen that the extension 65 extends almost to the floor of the pump chamber 17. The roll bellows 19 which forms the pump is folded in, with a downwardly open U-deflection between the extension 65 and the wall 64.

The illustrative representation is schematic. In fact, there is a very precise guidance between the extension 64, which is insured by the roll bellows 19 folded therebetween, as shown in FIG. 16.

The valve V2 acts as a non-return valve. With the volume reduction of the pump chamber 17, it blocks the viscous, pasty compound 6 against flowing back into the supply chamber 16 of the cartridge 15. With regard to the supply chamber 16, a closed level column remains, which enables re-aspiration.

The cartridge 15, which is realized as a twin-cartridge further operates with a sliding membrane 20. The lower half the content of the cartridge 15 is collected in a bag, which inverts as a result of the evacuation underpressure produced in the pump chamber 17. An air balancing opening 28′ is situated underneath the bag on the container floor 28.

As can be seen in FIGS. 11 and 13, the edge ‘20’ of the bag at the sliding membrane 20 is picked up at half axial length of the supply chamber.

With regard to the dispenser mechanics, the telescoping means are used for delivery. Accordingly, a multi-part telescoping dispenser housing 21 is provided. Two telescoping housing parts 22, 23 are located in the inside region and are overlapped in part by a further telescoping housing part, namely, an upper housing part 24. (See FIG. 2).

The telescoping housing part 22 passes into a freely projecting retaining clip 25. The clip 25 is dimensioned and formed so that it has, together with the telescoping housing part 23 associated with it, a receptacle 26 for the supply part II and which opens transverse to the direction of movement (arrow x) of the operating part I. The cartridge chamber obtained in this fashion is closed off by a support wall 27. The floor 28 of the supply part II runs up to the support wall. The transversely open receptacle 26 is defined by a stop. In addition, the telescoping housing part 23 runs up, with a pin 29, against a slot end 30 of a longitudinal slot 31 of the upper housing part 24. This is a spring-biased initial position.

A corresponding, pre-stressed reset spring 32 is supported on a rear transverse wall 33 of the upper housing part 24. The spring 32 is positioned in a spring chamber 34. In contrast, the end of the reset spring 32 facing the receptacle 26 is set on a longitudinally centrally located guide pin 35. The guide pin 35 is incorporated in the back of the support wall 27 and has a free end formed as a truncated conical taper.

With displacement of the upper housing part 24 in the operating direction (arrow x), the reset spring 32, which is formed as a compression spring, is compressed, whereby the guide pin 35, which is located within the spring 32, can extend into the spring chamber 34.

The two telescoping housing parts 22, 23 are otherwise so formed, that during pushing of the supply part II into the receptacle 26, both an axial locking relative to the pump chamber cover 18 and relative to the supply chamber 16 is accomplished. The pump chamber cover 18 is locked with the telescoping housing part 22 abutting the retaining clip 25, and the supply chamber 16 is formed by the cartridge 15 and the telescoping housing part 23.

The telescoping housing part 22 forms a transverse groove 36 opening inwardly that is, into the adjusting bracket space. Thereinto projects an outwardly located transverse rib 37 of the pump chamber cover 18. The transverse rib 37 is realized on a yoke 38 that includes the conduit sections of the pump chamber cover 18 leading to the mouthpiece 8. The transverse groove 36 and the transverse rib 37 are impressed in the groove/spring manner on both yoke sides.

The locking of the supply part II on the corresponding telescoping housing part 23 also occurs in the groove/spring manner. The telescoping housing part 23 has oriented inwardly in the direction of the arrow x, projections 23′ of which cooperate with inwardly opening, transverse grooves 39. Corresponding segments of a connection bead 40 of the housing halves of the cartridge 15 project as transverse ribs 41 into the groove 39. With this formlocking connection, the floor 28 becomes flush with the surface of the support wall 27. Thus, the cartridge 15 is securely seated on the telescoping housing part 23.

The bridging part of the retaining clip 25 leaves a sufficient transverse slot 42 for insertion in of the mouthpiece cross-section, whether it is formed as a twin tube or as a single tube, as can be seen in FIG. 14.

The telescoping housing parts 22, 23 are connected with a lever transmission system allowing telescoping at moderate force. It can be seen that this is an indirect connection. It is effected using a ring member 42. The ring member 42 extends, facing away from the receptacle 26, in the back of the support wall 27 of the dispenser 1. The ring member 42 is axially displaceable. The clip ends of the retaining clip 25 of the telescoping housing part 22 are fixedly secured to the ring member 42. The fastening point can be identified by a rivet 43. In order to provide insight into the assembly, the ring member 42 is broken away in the central region.

The connection of the telescoping housing part 22 with the telescoping housing part 23 is effected by crossing each other, double-arm levers 44. Their longer arm a running transverse to the direction of operation (arrow x) engages, via an articulation 45, the rear wall 33 of the upper housing part 24. From the rear wall 33, mounting blocks 46 project into the receiving space of the lever 44. The articulation 45 forms, on the lever side, longitudinal openings 47 as movement compensation.

The end segments of the lever 44 facing towards the telescoping housing part 23 are seated on articulations 48, set by mounting blocks 49 imbedded in the back of the support wall 27. This is the connection with the telescoping housing part 23.

The lever 44 extends into a further external articulation 50. The shorter arm b of the lever 44 runs between the two articulations 48, 50. The ratio is about 4:1. The articulations 45, 48 are flush at the same height.

From the inner side of the ring member 42, bearing blocks 51 extend for forming the articulation 50. The shorter arm b assumes a radial course in the initial position (FIG. 6), recognizably parallel to the support wall 27. The inclination angle of the lever 44 relative to the basic support wall 27 is approximately 30°. It diminishes when operated (FIG. 7).

In order to prevent radial tension from acting on the ring member 42 upon pivoting operation of the lever 44, one of the articulations must be relieved by the formation of elongate openings, e.g., designated with a reference numeral 47.

Pivoting of the lever 44 occurs, as has already been indicated, by application of manual force to the upper housing part 24, which results in a relative movement between the two telescoping housing parts 22, 23. By appropriate biasing of the ring member 42 against the direction of operation (arrow x), tension is applied to the retention clip 25 and, thus, to the telescoping housing part 22. The pump chamber cover 18 moves in order to effect a volume reduction of the pump chamber 17. This occurs against the force of the expanding reset spring 32. And also against the press-on direction of the tool relative to the to-be-filed part 3. The part 3 is stressed in such a fashion at the time of the filling operation and even further by the tool that it is reliably held at the wall surface. The volume-reducing output stroke y is represented in terms of path in FIG. 7 (moving away of the ring member 42 from the part 23).

The hardenable, viscous-pasty compound 6 that is to be applied to the target area, contains a high-quality mixture, when the mixing is done already in a mixing path upstream on the pump chamber side of the dispensing opening 9. The mixing is effected with coil mixing elements 52 in the tubular mouth piece 8. The foot of the mouthpiece 8 has a non-round, rotary, wedge-shaped base 53, which can be conveniently associated with an edge-overlapping mounting 54 of the mouthpiece 8 which tightly seals the base 53.

When in storage or not in use, the mouthpiece 8 can be closed using an attached protective cap 55, which is secured with a band against loss and has a plug projection 56. The latter can be brought to a non-interfering position when in use, with the plug projection 56 being inserted into a matching receptacle hole 57 of the retention clip 25. A friction-locking arrangement is fully adequate.

FIGS. 6 and 7 make clear that the illustrated telescoping arrangement can be arbitrarily selected. The corresponding selection device is designated with numeral 58. It has a rotary knob 59 in the upper housing part 24 and a switch finger 60. The switch finger 60 is subjected to the action of a corresponding, displaceably relative thereto link 61, which provides a short range and a long range. The link 61 is situated in the telescoping housing part 23.

With regard to the supply part II, it should be noted that the cartridge 15 is realized as a refillable cartridge that can be refilled with the two components. For this purpose the supply chamber 16 of the cartridge 15 has union-shaped filling columns 62 at the highest point. They can be filled up to the rim (FIG. 12). The excess compound 6 can be compressed using a lockable, cup-shaped stopper 63. The excess is compressed in the head of the dispenser 1 relative to the cartridge 15, so that the first operating stroke is already a working stroke.

The telescoping housing part 22, 23 and the upper housing part 24 are formed on the operating part I; in contrast, the dispensing opening 9, the pump chamber 17 and the supply chamber 16 are provided in on the supply part II.

Though the present invention was shown and described with references to the preferred embodiment, such is merely illustrative of the present invention and are not to be construed as a limitation thereof and various modifications of the present invention will be apparent to those skilled in the art. It is, therefore, not intended that the present invention be limited to the disclosed embodiment or details thereof, and the present invention includes all variations and/or alternative embodiments within the spirit and scope of the present invention as defined by the appended claims.

What is claimed is:

1. A dispenser (1) for filling a to-be-filled part (3) with a hardenable, viscous, pasty compound (6), comprising a multi-part housing (21) having telescopingly arranged within each other, telescoping housing parts (22, 23) and a dispensing opening (9); a supply chamber (16) for storing the hardenable, viscous, pasty compound (6); a variable pump chamber (17) for delivering the compound through the dispensing opening (9) and adjoining the supply chamber (16); a cover (18) for covering the pump chamber (17) and displaceable relative to the pump chamber (17) between a first position, in which the pump chamber (17) has an initial volume, and a second position in which the pump chamber (17) has a reduced volume; and a reset spring (32) arranged outside of the pump chamber (17) for returning the pump chamber cover (18) to the first position thereof,
wherein delivery of the compound (6) through the dispensing opening (9) is effected by applying a compression force to a rear, with respect to a delivery direction, side of the housing (21), whereby the dispensing opening (9) is pressed against the to-be-filled part (3), and the volume of the pump chamber (17) is reduced as a result of the pump chamber cover (18) being displaced to the second position thereof resulting from a telescopic displacement of the housing parts (22, 23) toward each other under action of the compression force applied to the rear side of the housing (21), and
wherein the pump chamber (17) is refilled by the compound (6) upon removal of the compression force and displacement of the pump chamber cover (18) to the first position thereof as a result of movement of the housing parts away from each other under action of a biasing force of the reset spring (32).

2. A dispenser according to claim 1 further comprising a lever transmission system for telescopically connecting the housing parts (22, 23).

3. A dispenser according to claim 2, further comprising a ring member (42) associated with one of the housing parts (23), the lever transmission system acting between the ring member (42) and another of the housing parts (22).

4. A dispenser according to claim 1, wherein the housing (21) includes an upper housing part (24) to which the compression force is applied, the housing parts (22, 23) being displaceable relative to the upper housing part (24).

5. A dispenser according to one claim 1, wherein the dispenser (1) comprises operating part (I), and a replaceable supply part (II), and wherein the telescoping housing parts (22, 23) and the upper housing part (24) are provided on the operating part (I) and the dispensing opening (9), the pump chamber (17), and the supply chamber (16) are provided on the supply part (II).

6. A dispenser according to claim 5, wherein the operating part (I) has a receptacle (26) for receiving the supply part (II) and opening transverse to the delivery direction.

7. The dispenser according to claim 6 wherein during pushing of the supply part (II) into the receptacle (26), both an axial locking relative to the pump cover (18) and relative to the supply magazine (16) occurs with each one of the telescoping housing parts (22, 23).

8. A dispenser according to claim 1, further comprising a mixing path (7) located in the dispensing opening (9) and downstream of the pump chamber (17).

9. A dispenser according to claim 1, further comprising a filling column (62) associated with the supply chamber (16) and having a stopper (63) for determining a volume of the compound (6).

10. A supply part for a dispenser for filling a to-be-filled part (3) with a hardenable, viscous pasty compound (6), comprising a multi-part housing (21) having telescopingly arranged within each other, telescoping housing parts (22, 23) and a dispensing opening (9); a supply chamber (16) for storing the hardenable, viscous, pasty compound (6); a variable pump chamber (17) for delivering the compound through the dispensing opening (8) and adjoining the supply chamber (16); a cover (18) for covering the pump chamber (17) and displaceable relative to the pump chamber 917) between a first position, in which the pump chamber (17) has an initial volume, and a second position in which the pump chamber (17) has a reduced volume; and a reset spring (32) arranged outside of the pump chamber (17) for biasing the pump chamber cover (18) to the first position thereof, the supply part (II) comprising the supply chamber (16), the pump chamber (17), and the dispensing opening (9) configured at a mouthpiece (8) connected to a pump chamber cover (18) and having a first locking formation, and that the storage chamber (16) is configured with a second locking formation.

11. A supply part according to claim 10 comprising a two-chamber element with each chamber having an outlet, and conduit means communicating the outlets with the mouthpiece (8) and including a mixing path (7) in which two components of the compound (6) intermix.

12. A supply part according to claim 11, wherein the two-chamber element is formed of two cartridges (15).

13. A dispenser according to claim 1, further comprising means for displacing the pump chamber cover (18) to the first position thereof upon displacement of the housing parts (22, 23) away from each other under the action of the biasing force of the reset spring (32).

14. A dispenser according to claim 1, comprising means for converting a biasing force of the reset spring (32) into a pulling force for displacing the pump chamber cover (18) from the second position thereof to the first position thereof.

15. A dispenser according to claim 1, further comprising means for adjusting a displacement path of the telescopic displacement of the housing parts (22, 23) relative to each other.

16. A dispenser according to claim 1, wherein the pump chamber (17) is formed by a roll bellows (19).
